(19) United States
(12) Patent Application Publication
(10) Pub. No.: US 2017/0344602 A1
(43) Pub. Date: Nov. 30, 2017

(54) SYSTEM AND METHOD FOR ABSTRACTED AND FRAGMENTED DATA RETRIEVAL

(71) Applicant: Joan Hada, Overland Park, KS (US)

(72) Inventor: Joan Hada, Overland Park, KS (US)

(21) Appl. No.: 15/603,073

(22) Filed: May 23, 2017

Related U.S. Application Data
(60) Provisional application No. 62/340,804, filed on May 24, 2016.

(51) Int. Cl. G06F 17/30

(52) U.S. Cl. CPC G06F 17/30371; G06F 17/30312

(57) ABSTRACT

A computer-implemented method for storing information in a plurality of storage devices. The method includes receiving a transaction record and parsing the transaction record into a plurality of data chunks. The method also includes designating a storage device having a location ID for each of the plurality of data chunks. The method further includes designating a chunk ID for each of the plurality of data chunks. The method still further includes distributing the location IDs to a location ID database, distributing the chunk IDs to a chunk ID database, and distributing each of the plurality of data chunks to the corresponding designated storage device for storage. The method yet still further includes relating the plurality of chunk IDs to each other in the chunk ID database, and relating each location ID to the corresponding chunk ID in at least one of the location ID database and the chunk ID database.

### RELATED APPLICATIONS

The current patent application is a non-provisional patent application which claims priority benefit to identically-titled U.S. Provisional Application Ser. No. 62/340,804, filed May 24, 2016, which is hereby incorporated by reference in its entirety into the current patent application.

### FIELD OF THE INVENTION

The present disclosure generally relates to computing devices, software applications, computer-readable media and computer-implemented methods for securely storing information to a plurality of storage devices.

### BACKGROUND

Existing methods for fragmented, distributed data storage rely heavily on altering data blocks from their original form—for example through use of encryption and other techniques—in attempts to store each block more securely against unauthorized access and/or use. However, such methods can be prohibitively expensive and/or may increase the complexity of, and lengthen the time required for, data retrieval. An improved method for securely storing information to, and retrieving information from, a plurality of storage devices is needed.

### BRIEF SUMMARY

Embodiments of the present technology relate to computing devices, software applications, computer-implemented methods, and computer-readable media for securely storing information to a plurality of storage devices. Embodiments of the present invention address one or more of the above-discussed problems by emphasizing the natural defenses of a set of distributed storage devices.

In a first aspect, a computer-implemented method for storing information in a plurality of storage devices may be provided. The method may include, via one or more processors and/or transceivers: (1) receiving a transaction record; (2) parsing the transaction record into a plurality of data chunks; (3) designating a storage device having a location ID for each of the plurality of data chunks; (4) designating a chunk ID for each of the plurality of data chunks; (5) distributing the location IDs to a location ID database; (6) distributing the chunk IDs to a chunk ID database; (7) distributing each of the plurality of data chunks to the corresponding designated storage device for storage; (8) relating the plurality of chunk IDs to each other in the chunk ID database; and/or (9) relating each location ID to the corresponding chunk ID in at least one of the location ID database and the chunk ID database. The method may include additional, fewer, or alternative actions, including those discussed elsewhere herein.

In another aspect, a computing device for storing information in a plurality of storage devices may be provided. The computing device may include a communication element, a memory element, and a processing element. The communication element may be configured to provide electronic communication with a communication network. The processing element may be electronically coupled to the memory element. The processing element may be configured to: (1) receive a transaction record; (2) parse the transaction record into a plurality of data chunks; (3) designate a storage device having a location ID for each of the plurality of data chunks; (4) designate a chunk ID for each of the plurality of data chunks; (5) distribute the location IDs to a location ID database; (6) distribute the chunk IDs to a chunk ID database; (7) distribute each of the plurality of data chunks to the corresponding designated storage device for storage; (8) relate the plurality of chunk IDs to each other in the chunk ID database; and/or (9) relate each location ID to the corresponding chunk ID in at least one of the location ID database and the chunk ID database. The computing device may include additional, fewer, or alternate components and/or functionality, including that discussed elsewhere herein.

In yet another aspect, a software application for storing information in a plurality of storage devices may be provided. The software application may be configured to: (1) receive a transaction record; (2) parse the transaction record into a plurality of data chunks; (3) designate a storage device having a location ID for each of the plurality of data chunks; (4) designate a chunk ID for each of the plurality of data chunks; (5) distribute the location IDs to a location ID database; (6) distribute the chunk IDs to a chunk ID database; (7) distribute each of the plurality of data chunks to the corresponding designated storage device for storage; (8) relate the plurality of chunk IDs to each other in the chunk ID database; and/or (9) relate each location ID to the corresponding chunk ID in at least one of the location ID database and the chunk ID database. The software application may include additional, less, or alternate functionality, including that discussed elsewhere herein.

Advantages of these and other embodiments will become more apparent to those skilled in the art from the following description of the exemplary embodiments which have been shown and described by way of illustration. As will be realized, the present embodiments described herein may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of computing devices, software applications, computer-readable media and computer-implemented methods disclosed therein. It should be understood that each Figure depicts an embodiment of a particular aspect of the disclosed computing devices, software applications, and computer-implemented methods, and that each of the Figures is intended to accord with a possible embodiment thereof. Further, wherever possible, the following description refers to the reference numerals included in the following Figures, in which features depicted in multiple Figures are designated with consistent reference numerals. The present embodiments are not limited to the precise arrangements and instrumentalities shown in the Figures.

FIG. 1 illustrates an exemplary environment in which various components of a computing device may be utilized, the computing device configured to store information in a plurality of storage devices;

FIG. 2 illustrates various components of an exemplary data manager shown in block schematic form;

FIG. 3 illustrates various components of the exemplary computing device shown in block schematic form;

FIGS. 4A and 4B illustrate at least a portion of the steps of an exemplary computer-implemented method for securely storing information to, and retrieving information from, a plurality of storage devices;

FIGS. 5A and 5B illustrate at least a portion of the steps of a second exemplary computer-implemented method for securely storing information to, and retrieving information from, a plurality of storage devices;

FIG. 6 is a table illustrating a portion of a chunk ID database at an intermediate point in the second exemplary method;

FIG. 7 is a table illustrating a portion of a user key database at an intermediate point in the second exemplary method; and

FIG. 8 is a table illustrating a portion of a location ID database at an intermediate point in the second exemplary method.

The Figures depict exemplary embodiments for purposes of illustration only. One skilled in the art will readily recognize from the following discussion that alternative embodiments of the systems and methods illustrated herein may be employed without departing from the principles of the invention described herein.

### DETAILED DESCRIPTION

The present embodiments described in this patent application and other possible embodiments may relate to, inter alfa, computing devices, software applications, computer-readable media and computer-implemented methods that provide improvements to the manner in which computing devices manage secure distributed data storage. Embodiments of the present invention provide improvements in storing information to and retrieving information from a plurality of standalone storage devices and providing such information to one or more thin clients or client electronic devices.

A computing device, through hardware operation, execution of a software application, implementation of a method, or combinations thereof, may be utilized as follows. The computing device may operate in a web or network communication environment in which users, such as customers or potential customers, an organization and/or its employees are trying to securely store and retrieve information, such as information, data and files generated during a user session in a software application running at an electronic device of a user.

The computing device, such as a data, file, or web server, may execute a data manager, which includes the following components: a core storage manager, random number generator, storage device assignor and storage device database. Preferably, the computing device also accesses at least two, and more preferably three, databases residing on separate, standalone storage devices. However, one or more of the databases, discussed in more detail below, may be incorporated into the computing device and/or data manager without departing from the spirit of the present invention. More preferably, each standalone storage device also comprises a data silo.

Moreover, in some embodiments, the computing device may also execute the thin client, which may be a component of, or in communication with, a web interface on a website which receives requests and/or inputs from the user. The thin client may additionally or alternatively be a component of, or in communication with, an interface for data retrieval software utilized within a group, company, or corporation and may be executed on a user electronic device.

During operation, a user (customer, potential customer, organization, employee, etc.) may, through a web browser, thin client and/or other software interface, request storage and/or retrieval of a transaction record. The web browser, thin client and/or other software interface may be configured in advance with settings and parameters customizable for the user. For instance, the user may engage in an account setup process as an individual or on behalf of an organization. During the account setup process, the user may broadly define the number and/or type of storage devices that may be used to populate a storage device list for designating storage devices for the user's data storage/retrieval requests. Preferably, the user is permitted to designate one or more internal (i.e., user-controlled) storage devices and/or a class or type of such devices, and/or may designate the number, class and/or type of one or more external storage devices. More particularly, the user is preferably permitted to designate specific internal devices for use as storage devices in connection with aspects of the present invention, but is preferably not permitted to select specific external devices. Instead, the user is preferably limited with respect to external device selections to aspects such as the number, class or type of any such external storage device(s), it being preferable for the specific storage device(s) populating each storage device list to remain as confidential as possible.

The user may also be permitted to configure account settings and parameters to define one or more default chunk sizes for use in delimiting transaction records originating, for example, with one or more user applications. The user may be permitted to configure account settings and parameters to define one or more data type exceptions that may, for example, require deviation from any default chunk size parsing setting(s) in the event a particular type of data is encountered in a transaction record, as described in more detail below. Similarly, the user may be permitted to configure account settings and parameters to define transaction record length and/or composition. Moreover, the user may be permitted to select one or more user keys, which may be one or more unique personal identifiers passed to the core storage manager to associate the user with one or more transaction records for authorized storage and/or retrieval, also as discussed in more detail below. The user may also configure account settings and parameters—including with respect to default chunk sizes, data type exceptions, transaction record length and/or composition, and/or user keys—for use variously across user software applications and/or within each user software application.

Returning to description of normal operation following account setup according to an exemplary embodiment, a user may execute a user software application at a user electronic device. The thin client may receive a transaction record from, and/or that was generated through use of, the user software application. The thin client may also, directly or indirectly, receive a request for secure storage of the transaction record. The transaction record may or may not be of pre-defined length and/or composition without departing from the spirit of the present invention.

The core storage manager may receive the transaction record, request for storage, and user key from the thin client. Typically, the user and/or the thin client will also provide a user key for associating the transaction record with the user to enable subsequent retrieval and/or user authorization. However, it is foreseen that various other methods for associating the user to the transaction record may be utilized without departing from the spirit of the present invention.

Broadly speaking, the core storage manager may divide or parse the transaction record into a plurality of data chunks, delimiting the data chunks according to one or more default chunk size parameter(s) and/or data type exception(s). For each data chunk, the data manager preferably designates a storage device having a location ID, designates a chunk ID, distributes the location ID to a location ID database, distributes the chunk ID to a chunk ID database, relates the chunk ID to at least one other chunk ID in the chunk ID database, and relates the location ID to the chunk ID in at least one of the location ID database and the chunk ID database. The data manager may perform and/or instruct performance of one or more of these operations for each data chunk before parsing and/or performing other operations on the next or successor data chunk. However, it is foreseen that at least some of these operations with respect to each data chunk may be overlapped with such operations with respect to the predecessor, successor, or other data chunks of a transaction record, and/or that the data manager may otherwise prioritize its operations for optimal performance and/or efficiency, for example, without departing from the spirit of the present invention.

In the preferred embodiment, the transaction record is parsed and distributed for storage in a plurality of standalone storage devices. Moreover, the database records for linking the user (e.g., via a user key) to at least a portion of the transaction record, for linking the data chunks to one another, and for linking the data chunks to their respective storage devices, are all distributed across three databases comprising and/or stored on at least three standalone storage devices. Namely, each of the location ID database, chunk ID database, and user key database preferably comprises and/or resides on a different standalone storage device than the other databases. Metadata regarding the transaction record and/or one or more of its data chunks may optionally be stored in one or more of the databases to enhance the ease and/or efficacy of focused retrieval processes, administrative testing and/or reporting, or other customary database management or maintenance processes.

To access the transaction record following storage, the user may request retrieval via the thin client, which may pass the request—along with any metadata regarding the transaction record and/or any of its chunks that might narrow the focus of the request—to the data manager. Typically, the user key will be passed from the thin client to the data manager with and/or in conjunction with the retrieval request. The data manager may receive the retrieval request, any associated metadata, and the user key, and begin the retrieval process. The data manager may first directly or indirectly locate the user key in the user key database to retrieve an identifier associated with at least one chunk of the transaction record, with such identifier also being present in association with the transaction record in the chunk ID database. In one embodiment, the identifier is the chunk ID of a first chunk of the transaction record.

The data manager may then retrieve all the chunk IDs of the transaction record using the chunk ID database and the first chunk ID retrieved from the user key database, the plurality of chunks of the transaction record having been related to each other during the storage process as outlined above. The data manager may also identify a location for each storage device on which at least one of the data chunks is stored using the location ID database, the plurality of location IDs having been respectively related to corresponding chunk IDs within at least one of the location ID database and the chunk ID database during the storage process as outlined above. The data manager may retrieve the plurality of data chunks from the located storage devices and render them back to the thin client for display to and/or storage/use by the user. The data manager may assemble the plurality of data chunks before rendering the transaction record to the thin client.

The present embodiments may provide computing devices, software applications, computer-readable media and computer-implemented methods for secure distributed storage of transaction records without the requirement for encryption or other alteration of the content of the data chunks themselves. In a preferred embodiment, a transaction record and metadata regarding the transaction are dispersed in the manner provided herein to greatly decrease the likelihood an unauthorized person will be able to: access and/or assemble a transaction record; identify or understand the import or contents of one or more of the data chunks comprising a transaction record; and/or link the data chunks and/or transaction record to a particular user.

### Exemplary System

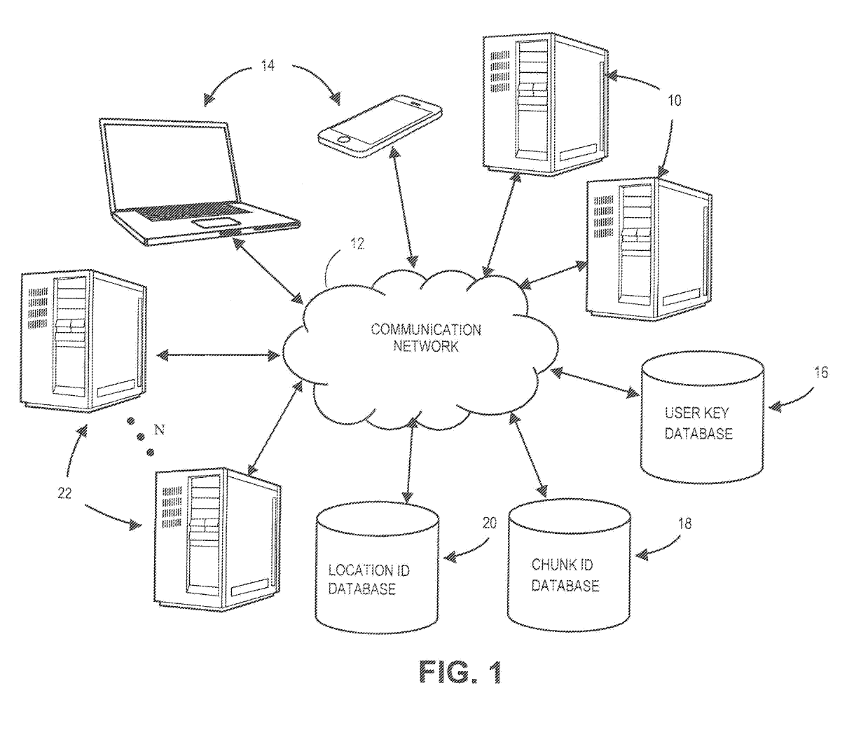

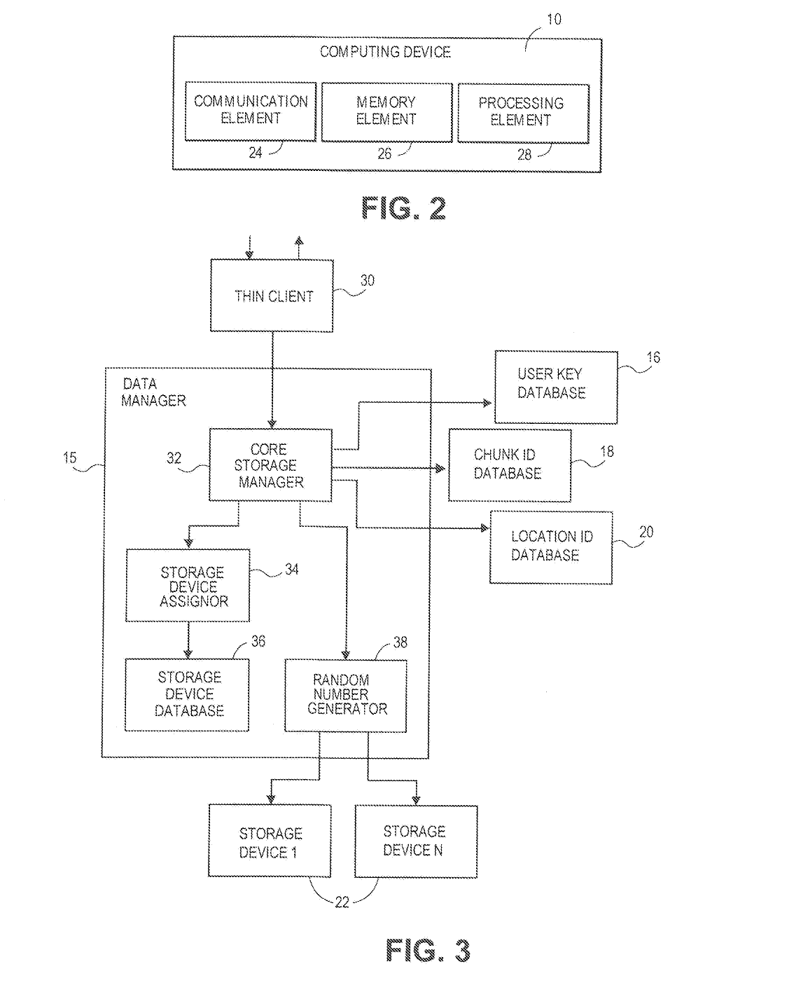

FIG. 1 depicts an exemplary environment in which embodiments of a computing device 10 may be utilized. The environment may include a communication network 12 and a plurality of electronic devices 14. The computing device 10 may execute a data manager 15, shown in FIG. 2, which stores information to and retrieves information from a plurality of storage devices 22 in response to request(s) issued by one or more users of the plurality of electronic devices 14. The data manager 15 may be utilized in a web environment, wherein one or more users, each using an electronic device 14, are trying to store and/or retrieve information through the communication network 12. For example, a user may request secure storage of a transaction record including an e-mail via a thin client software application 30 running locally at one of the electronic devices 14.

The communication network 12 generally allows communication between the electronic devices 14, the computing devices 10, one or more databases 16, 18, 20, and/or a plurality of storage devices 22. The communication network 12 may include local area networks, metro area networks, wide area networks, cloud networks, the Internet, cellular networks, plain old telephone storage device (POTS) networks, and the like, or combinations thereof. The communication network 12 may be wired, wireless, or combinations thereof and may include components such as modems, gateways, switches, routers, hubs, access points, repeaters, towers, and the like. The electronic devices 14, the computing devices 10, one or more of the databases 16, 18, 20 and/or the plurality of storage devices 22 may connect to the communication network 12 either through wires, such as electrical cables or fiber optic cables, or wirelessly, such as radio frequency (RF) communication using wireless standards such as cellular 2G, 3G, 4G or 5G Institute of Electrical and Electronics Engineers (IEEE) 802.11 standards such as WiFi, IEEE 802.16 standards such as WiMAX, Bluetooth™, or combinations thereof.

Each electronic device 14 may include data processing and storage hardware, a display, data input components such as a keyboard, a mouse, a touchscreen, etc., and communication components that provide wired or wireless communication. Each electronic device 14 may further include software such as a web browser, user software applications such as e-mail applications and/or word processing or other applications, and thin client 30 for interfacing with the data manager 15. Examples of the electronic devices 14 include desktop computers, laptop computers, palmtop computers, tablet computers, smart phones, wearable electronics, smart watches, wearables, or the like, or combinations thereof.

The databases 16, 18, 20 may be embodied by any organized collection of data and may include schemas, tables, queries, reports, and so forth which may be implemented as data types such as bibliographic, full-text, numeric, images, or the like and combinations thereof. The databases 16, 18, 20 may be stored in memory that resides in one computing machine, such as a server, or, preferably, may be stored respectively in separate standalone computing machines. In some embodiments, one or more of the databases 16, 18, 20 may reside in the same machine as one of the electronic devices 14 or the computing device 10. The computing device 10 may communicate with the databases 16, 18, 20 through the communication network 12 or directly. In addition, the databases 16, 18, 20 may interface with, and be accessed through, one or more database management systems, as is commonly known, in addition to or complementary with direct or indirect interfacing with the data manager 15.

Each of the plurality of storage devices 22 generally stores data, is typically embodied by a data server, and may include storage area networks, application servers, database servers, file servers, gaming servers, mail servers, print servers, web servers, or the like, or combinations thereof. The storage devices 22 may be additionally or alternatively embodied by computers, such as desktop computers, workstation computers, or the like. The plurality of storage devices 22 may be configured to store data in normalized and/or non-normalized formats. Of particular note, embodiments of the present invention may securely store data chunks in non-normalized formats for later retrieval without the assistance of indices, key fields and/or structured metadata stored at the storage devices 22.

The computing device or devices 10, as shown in FIG. 2, may broadly comprise a communication element 24, a memory element 26, and a processing element 28. Examples of the computing device 10 may include one or more computer servers, such as web servers, application servers, database servers, file servers, or the like, or combinations thereof. The computing device 10 may additionally or alternatively include computers such as workstation or desktop computers.

The communication element 24 generally allows the computing device 10 to communicate with the communication network 12, other computing devices 10 and/or one or more of databases 16, 18, 20. Also, the data manager's 15 communication with the thin client 30 and the storage devices 22 may occur using the communication element 24. The communication element 24 may include signal and/or data transmitting and receiving circuits, such as antennas, amplifiers, filters, mixers, oscillators, digital signal processors (DSPs), and the like. The communication element 24 may establish communication wirelessly by utilizing RF signals and/or data that comply with communication standards such as cellular 2G, 3G, 4G, or 5G, WiFi, WiMAX, Bluetooth™, or combinations thereof. Alternatively, or in addition, the communication element 24 may establish communication through connectors or couplers that receive metal conductor wires or cables which are compatible with networking technologies such as ethernet. In certain embodiments, the communication element 24 may also couple with optical fiber cables. The communication element 24 may be in communication with the memory element 26 and the processing element 28.

The memory element 26 may include data storage components such as read-only memory (ROM), programmable ROM, erasable programmable ROM, random-access memory (RAM) such as static RAM (SRAM) or dynamic RAM (DRAM), cache memory, hard disks, floppy disks, optical disks, flash memory, thumb drives, universal serial bus (USB) drives, or the like, or combinations thereof. In some embodiments, the memory element 26 may be embedded in, or packaged in the same package as, the processing element 28. The memory element 26 may include, or may constitute, a “computer-readable medium.” The memory element 26 may store the instructions, code, code segments, software, firmware, programs, applications, apps, standalone storage devices, daemons, or the like, including the data manager 15, that are executed by the processing element 28.

The processing element 28 may include processors, microprocessors (single-core and multi-core), microcontrollers, digital signal processors (DSPs), field-programmable gate arrays (FPGAs), analog and/or digital application-specific integrated circuits (ASICs), or the like, or combinations thereof. The processing element 28 may generally execute, process, or run instructions, code, code segments, software, firmware, programs, applications, apps, processes, standalone storage devices, daemons, or the like. The processing element 28 may also include hardware components such as finite-state machines, sequential and combinational logic, and other electronic circuits that may perform the functions necessary for the operation of the current invention. The processing element 28 may be in communication with the other electronic components through serial or parallel links that include address buses, data buses, control lines, and the like.

By utilizing hardware, firmware, software, or combinations thereof, the processing element 28 may perform the tasks taught herein. The processing element 28 may execute or run the data manager 15, which stores information to and retrieves information from one or more storage devices 22 and databases 16, 18, 20. The processing element 28 may provide information retrieved from the storage devices 22 to at least one thin client 30 for display and/or use at one or more of the electronic devices 14.

The data manager 15 may include a core storage manager 32, a storage device assignor 34 which may access a storage device database 36, and a random number generator 38. The storage device assignor 34 and/or storage device database 36 may reside on a physically separate computing device 10 from the core storage manager, which may reflect a customary division of responsibilities for a provisioning server or the like managing network elements and/or other system resources (e.g., storage devices 22). The core storage manager 32 may directly or indirectly store information to and retrieve information from a user key database 16, chunk ID database 18, and location ID database 20. The data manager 15 and the databases 16, 18 and 20 will be described in more detail below.

### First Exemplary Computer-Implemented Method

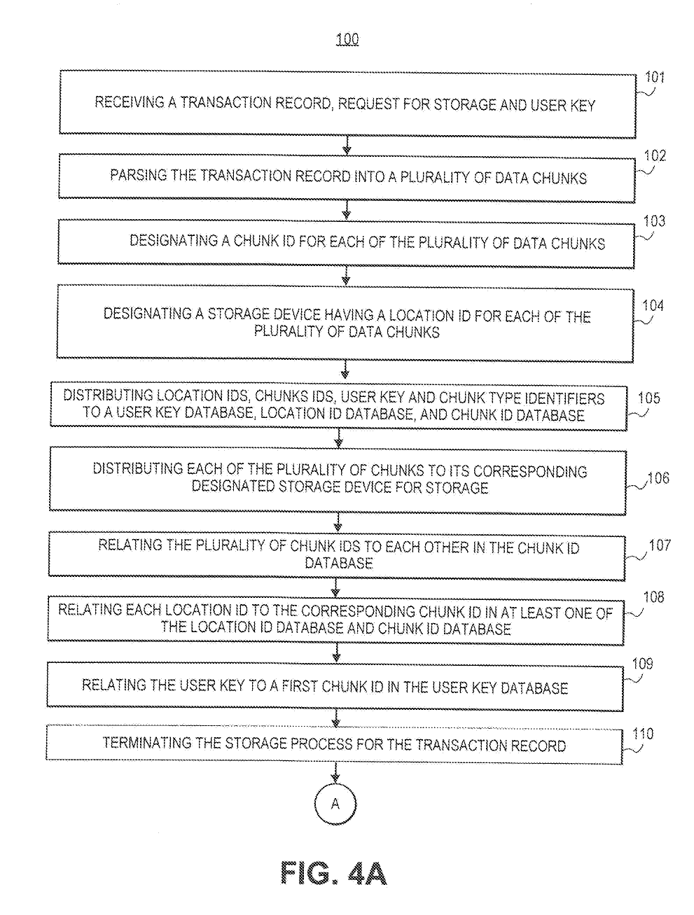

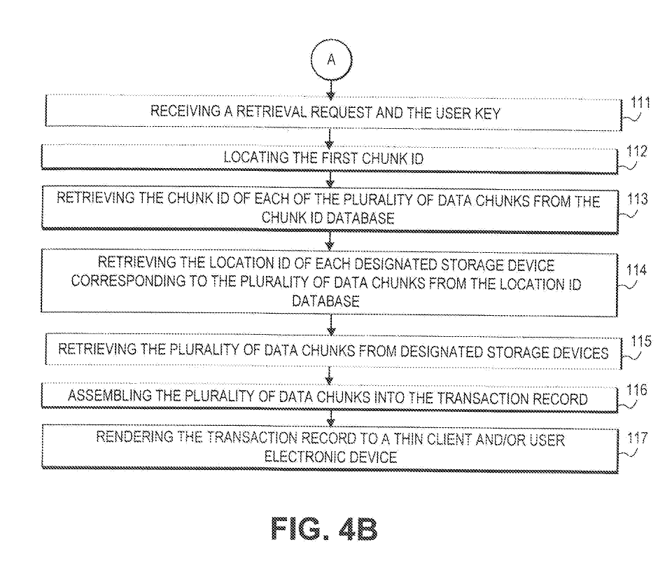

FIGS. 4A and 4B depict a listing of steps of an exemplary computer-implemented method 100 for storing information in a plurality of storage devices 22, and for retrieving the information and providing it to a thin client 30. The steps may be performed in the order shown in FIGS. 4A and 4B, or they may be performed in a different order. Furthermore, some steps may be performed concurrently as opposed to sequentially. In addition, some steps may be optional. The computer-implemented method 100 is described below, for ease of reference, as being executed by exemplary devices introduced with the embodiments illustrated in FIGS. 1-3. For example, the steps of the computer-implemented method 100 may be performed by the computing device 10 through the utilization of processors, transceivers, hardware, software, firmware, or combinations thereof. However, a person having ordinary skill will appreciate that responsibility for all or some of such actions may be distributed differently among such devices or other computing devices without departing from the spirit of the present invention. A computer-readable medium may also be provided. The computer-readable medium may include an executable program, such as a data manager, stored thereon, wherein the program instructs one or more processing elements to perform all or certain of the steps outlined herein. The program stored on the computer-readable medium may instruct the processing element to perform additional, fewer, or alternative actions, including those discussed elsewhere herein.

Referring to step 101, the data manager 15 may receive a transaction record, request for storage of the transaction record, and a user key. The transaction record may comprise data and information, and may be homogenous or heterogenous. For example, the transaction record may comprise a plurality of fields containing alphanumeric characters and/or groups of characters, structured and/or unstructured data, one or more files (e.g., system files, data files and/or program files) generated and/or stored at a user electronic device 14, and/or other types of data and information. The transaction record may be streamed and/or transmitted in one or more batches to the data manager 15.

The transaction record may include and/or be accompanied by metadata relating to the transaction record and/or one or more of its components. Such metadata may, in certain embodiments, indicate the origin(s) and/or originating circumstances of the transaction record and/or its component(s). For example, such metadata may indicate the software application(s) that contributed to the transaction record's contents, the time/date(s) of creation and/or storage of the data at the user electronic device 14, the types of data included in the transaction record, and other metadata that may help improve storage and/or retrieval of the transaction record via embodiments of the present inventive concept. Moreover, such information may be incorporated into the transaction record, and may be set off by field labels, key sequences, flags or similar information signaling the data manager 15 that specialized review and/or treatment may be needed to ensure optimized handling of the transaction record.

The transaction record may also be accompanied by and/or include information and instructions appended or otherwise related thereto by the thin client 30 relating to any of the foregoing aspects of the transaction record. Such instructions may include special handling instructions for the transaction record and/or relating to the particular user in question, and may be used by the data manager 15 to store and/or retrieve the transaction record. For instance, the thin client 30 may pass a transaction record-type such as “sensitive”—for example in a file header for the transaction record—to assist the data manager 15 in determining an appropriate sequence and type of steps for storing the transaction record according to its level of sensitivity. In an embodiment, a “sensitive” transaction record may be subjected to specialized parsing rules (e.g., providing for additional parsing/diffusion) and/or its data chunks may be stored according to a list of unusually secure storage devices 22 pursuant to certain aspects of the disclosure that follows.

The length and type of components included in the transaction record may be defined by the thin client 30 according to default setting(s) and/or as indicated by the user during an account setup process. For instance, the user may be an employee of an organization and, directly or indirectly (e.g., through proxy to a corporate administrator), may have previously set account settings and parameters defining one or more events that will trigger collection and transmission of a transaction record by the thin client 30. The one or more triggering events may include selection, creation and/or completion of one or more data and files and/or types of data and files, of one or more user sessions under a certain set of credentials and/or in one or more specified software applications, of one or more screens and/or sequences of screens to be “scraped,” and/or other recognizable system events that may be logged or otherwise determined by the electronic device 14. Such triggering events may be manually and/or automatically determined at the electronic device 14. For example, the user may manually select files to “back up” through the thin client 30 as they are saved to the electronic device, or the thin client 30 may be configured to perform automatic back ups periodically or in a streaming fashion without frequent user direction or input. Moreover, the triggering events may be variously configured for use with different software applications (e.g., desktop applications) and/or to handle different use scenarios within each software application.

The user key and request for storage may also be passed to the data manager 15 from the thin client 30, preferably in conjunction with or soon after transmission of the transaction record, though the data manager 15 may store a transaction record without instructions (and, in some cases, a user key) indefinitely according to certain embodiments. It is also foreseen that the user key and/or request for storage may be incorporated into the transaction record without departing from the spirit of the present invention. One of ordinary skill will recognize that omitting the request for storage entirely, and instead relying on the data manager 15 to acknowledge any such instruction implicitly from, for example, the passage of the transaction record to it from the thin client 30, or from other such events, is also clearly within the ambit of the present invention.

The user key is preferably a set of characters that serve as a unique identifier associated with: (1) only the individual user or group of users authorized to access the transaction record, for instance as determined at the time of storage; (2) only the transaction record to which it is specifically tied; or (3) both. For example, the user key may be a concatenation of a unique client ID number and the individual user's system login ID for the enterprise client's system. It is also foreseen that secure login, handshake authentication and/or other secure means for establishing an interface with the user electronic device 14 and/or thin client 30 may complement or substitute for passage of the user key directly to the data manager 15 in certain embodiments without departing from the spirit of the present invention. In such embodiments, the data manager 15 may key transaction records in one or more of databases 16, 18, 20 to the user according to records that index each client's login and/or handshake credentials with all or parts of the transaction records.

In some embodiments, individual user permissions with respect to transaction records may also or alternatively be managed in whole or in part by the thin client 30 or otherwise locally at the user electronic device 14. For instance, enterprise users may prefer the data manager 15 to assemble and render batches of transaction records to a local user server and permit the server to manage individual user permissions and access to such records. In such cases, the user key may simply be assigned to and/or otherwise represent authorized access by the enterprise as a whole.

Referring now to step 102, the core storage manager 32 may parse the transaction record into a plurality of data chunks. The core storage manger 32 may incorporate a number of parsing rules. The parsing rules may be specific to the user and/or transaction record and/or may be more generally applicable. The parsing rules may be pre-defined by the user and/or other administrative personnel, and/or may be determined at least in part according to metadata associated with, and/or generated by the data manager 15 through review of the contents of, the transaction record. In a preferred embodiment, the user setup process and/or user software applications interfacing with the thin client 30 provide(s) transaction records containing well-defined data fields which may be handled with ease using pre-defined sets of parsing rules optimized for use with the particular software application(s) that originated the transaction records. However, in certain embodiments, at least one parsing rule may be chosen through a computer detection process wherein the data manager 15 determines one or more aspects of the transaction record and/or associated metadata and selects the at least one parsing rule according to such a determination. It is also foreseen that the data manager 15 may employ supervised or unsupervised machine-learning techniques to guide selection of appropriate parsing rules without departing from the spirit of the present invention.

In a preferred embodiment, the core storage manager 32 may parse the transaction record according to parsing rules delineating between data chunks based at least in part on a chunk size parameter and/or based on at least one other aspect of one or more of the plurality of data chunks. A chunk size parameter may relate to the length of a group or string of characters and/or a file size, or to other aspects of the transaction record that generally relate to size. It is foreseen that other similar data and file attributes may comprise chunk size parameters without departing from the spirit of the present invention.

Other aspects that may be the subject of specialized parsing rules may relate to the types of information that are conveyed by or that make up one or more of the data chunks. For instance, a parsing rule may require the core storage manager 32 to treat as one data chunk any data that it is determined conveys a transaction type, for example a group of characters that comprise a label for the contents of the transaction record (e.g., “e-mail save” or “photo upload”). The parsing rule may incorporate parameters for identifying such a transaction metadata data chunk based on metadata labels passed to the data manager 15 with the transaction record and/or based on analysis of the data comprising the data chunk to determine it likely conveys a transaction type. Upon identification of such an aspect of the data chunk according to the parsing rule, the data chunk may be parsed from the transaction record as a single chunk regardless of whether it satisfies one or more parameters of otherwise applicable chunk size parsing rules. In some embodiments, such specialized parsing rules help to separate pieces of information that might be valuable to unauthorized users in attempting to make use of one or more data chunks. For example, parsing a file type transaction metadata data chunk before it reaches a particular size threshold may help avoid situations in which a general chunk size parsing rule would have otherwise stored a file type label with the file itself in the same data chunk, potentially compromising the security of the file.

Similarly, artifacts—such as contiguous desktop application files—may be identified within a transaction record and subjected to at least one specialized parsing rule. In an embodiment, each artifact may be treated as its own data chunk regardless of whether such artifact data chunk satisfies one or more parameters of otherwise applicable chunk size parsing rules. Artifact type exceptions may also or alternatively be configured to parse certain artifacts into a plurality of data chunks. For example, one or more artifact type exceptions may be configured to identify a file type. The artifact type exception may parse a file based on the file type into a predefined number of data chunks of particular size and/or by identifying particular landmarks within the file which, according to the rule, delineate the boundaries of individual data chunks. In an embodiment, personally identifiable information—or information considered by the artifact type exception as likely to be personally identifiable information—may be separated into different data chunks to enhance dispersion of sensitive information. Similar specialized parsing rules are preferably also developed to scan non-artifact data of transaction records for personally identifiable information or the like and, for example, perform additional parsing for enhanced dispersion of same across the storage devices 22.

It is foreseen that other parsing rules may be developed to assist the core storage manager 32 in delineating the plurality of data chunks according to the objectives of embodiments of the present invention. Preferably, parsing rules are selected so that, when applied together by the core storage manager 32 to a transaction record, an optimal balance is achieved between goals such as securely distributing and obscuring the content of particular data chunks, optimizing retrieval speed, and adherence to user settings and parameters.

The core storage manager 32 may additionally apply encryption and/or redaction techniques to the data chunks themselves for enhanced security. Such technologies are generally within the capabilities of one having ordinary skill, and will therefore not be discussed in additional detail herein.

The core storage manager 32 may direct temporary storage of the plurality of data chunks during and/or following parsing, which may include storing a replacement of data chunks with encrypted and/or redacted versions as outlined briefly above. For instance, the core storage manager 32 may direct storage of the data chunks at the computing device 10 until storage processes outlined below can be completed in the storage devices 22 and databases 16, 18, 20.

The core storage manager 32 may also memorialize operation of and/or threshold determinations made by any of the parsing rules by generating and storing one or more metadata labels with the affected data chunks of the transaction record. For instance, where a transaction type such as “e-mail save” is identified according to a transaction type exception and accordingly parsed as a separate transaction metadata data chunk, the core storage manager 32 may store “transaction type” in a field associated with the transaction metadata data chunk. Such metadata may be passed for storage along with the affected data chunks and/or their unique IDs (discussed in more detail below) in one or more of the user key database 16, chunk ID database 18, location ID database 20, and storage device(s) 22 in order to, for example, improve data retrieval and/or reporting activities.

Referring to step 103, the data manager 15 may designate a chunk ID for each of the plurality of data chunks of the transaction record. The chunk ID is preferably a unique set of characters within a set of all chunk IDs, and more preferably also within a set including all chunk IDs and all location IDs, in use in one or more of the databases 16, 18, 20. The chunk IDs may be generated according to any number of techniques for forming unique strings of characters or variables without departing from the spirit of the present invention. For instance, each chunk ID may be designated for a data chunk through hashing the data of the data chunk according to known deterministic techniques and algorithms. However, because each chunk ID is preferably unique, additional processing may be required for data chunks that are themselves not unique to the system (i.e., because the system has already saved a duplicate data chunk previously) before a hash number (as modified) may be designated as a chunk ID.

More preferably, the chunk ID may be designated in part using a random number generator 38. The random number generator 38 may be truly random or may be pseudorandom without departing from the spirit of the present invention. One of ordinary skill would also appreciate that a hardware random number generator is clearly within the ambit of the present invention.

The random number generator 38 may generate a random number candidate and search one or more of the databases 16, 18, 20 and/or an independent random number log for duplicate numbers already in use. If the random number candidate is found to be unique in the system, the core storage manager 32 may complete the designation step by storing the candidate in a field associated with the corresponding data chunk. The core storage manager 32 may also record a status—such as “selected”—in one or more of databases 16, 18, 20 (for instance in a field of a record associated with the data chunk in question) and/or in the independent random number log. The status of each random number may, alone or in conjunction with other information, be used in disaster recovery and/or failure investigations, for instance to determine when and if a storage process was prematurely aborted.

Referring to step 104, the data manager 15 may designate a storage device 22 having a location ID for each of the plurality of data chunks. Preferably, the core storage manager 32 calls a storage device assignor 34. The storage device assignor 34 accesses a storage device database 36 to obtain a list of storage devices 22 that the transaction record may be stored to. The storage device database 36 may be dynamic, and may be updated periodically with available devices according to user settings and parameters, third party service agreements, in view of available memory at individual storage devices 22, and according to other known factors that may affect optimal provisioning of network elements like the storage devices 22.

The storage device assignor 34 preferably randomly designates a storage device 22 from the list of storage devices 22 provided by the storage device database 36. It is foreseen that the storage device assignor 34 may prescreen the device list—for example to exclude overburdened, distant, or otherwise undesirable storage devices 22—before randomly designating a device 22 from among the surviving devices 22. However, a list of storage devices 22 surviving any such prescreening process preferably contains a significant number of viable storage devices 22 to ensure that unauthorized parties may not accurately predict where any particular data chunk may be designated for storage.

For each designated storage device 22, the storage device assignor 34 preferably also passes a location ID to the core storage manager 32 for recordation in the location ID database 20, as discussed in more detail below. The location ID is preferably a physical address, virtual address, logical address or the like used for identifying, and/or addressing storage and retrieval requests to, the storage device 22. Each location ID may also be revised by other processes described herein to include one or more physical addresses for memory locations within the storage device 22 to which the corresponding data chunk is stored, without departing from the spirit of the present invention.

Referring broadly to steps 105 to 109, the plurality of data chunks and corresponding chunk IDs, location IDs and, in many embodiments, the user key, may be distributed across and related within one or more of the databases 16, 18, 20 and storage devices 22, in various combinations according to operations performed in various orders. Preferably, at least one location ID is stored on a standalone device separate from the chunk ID database, at least because the chunk ID database is preferably where the plurality of chunk IDs are related to one another for purposes of retrieval and assembly (see steps 107 and 113, respectively). More preferably, all of the location IDs are stored on one or more standalone device(s) separate from the chunk ID database. Still more preferably, the user key is stored on a standalone device separate from the chunk ID database and from the location ID database.

In this manner, a transaction record according to a preferred embodiment is parsed and dispersed to greatly decrease the likelihood an unauthorized person will be able to: access and/or assemble an entire transaction record; identify or understand the import or contents of one or more of the data chunks comprising a transaction record; and/or link the data chunks and/or transaction record to a particular user. For instance, hacking the chunk ID database 18 will preferably not itself permit the hacker to identify the user to which a transaction record belongs, to locate the physical device locations to which the data chunks of the transaction record were stored, nor to obtain the actual data chunks themselves. Similarly, hacking the location ID database 20 may, by itself, merely permit a hacker to obtain physical device locations for millions (for example) of mostly unrelated data chunks, without permitting the hacker to link any such location IDs together for any single transaction record, to link any data chunk and/or transaction record to the user to which it/they belong, nor to obtain the actual data chunks themselves. It also follows that hacking the user key database 16 will preferably not permit a hacker to identify all the data chunks comprising a single transaction record, to obtain the physical device locations of any such data chunks, nor to obtain the actual data chunks.

The series of distribution and relation steps 105-109 may be carried out in various orders and in various manners to achieve the aforementioned objectives, as will become apparent upon review of this disclosure. Likewise, the database management systems comprising or cooperating with the data manager 15 in coordinating these steps, and indeed the structure of the databases 16, 18, 20 themselves, may vary with the chosen implementation of the present invention.

Returning to step 105 more specifically, in a preferred embodiment, the plurality of chunk IDs are distributed to the chunk ID database 18. Each chunk ID may also be distributed to the corresponding storage device 22 for storage with the corresponding data chunk (see step 106), which may, for example, bolster disaster recovery aspects of the system and provide an additional relationship for more robust indexing. Notably, distributing each chunk ID for storage with the corresponding data chunk at its designated storage device 22 may be required in some embodiments to enable location and retrieval of each data chunk from the corresponding designated storage device 22. More particularly, this may be the case in embodiments where the location ID does not itself specify the memory location(s) for the corresponding data chunk and/or where the chunk ID is not a hashed number representing the contents of the data chunk.

In addition—for instance in embodiments that utilize linked database structures such as those described hereinbelow—the chunk ID corresponding to the first data chunk parsed from the transaction record may also be distributed for storage with the user key in the user key database 16, for reasons described below in connection with step 109. Other distribution(s) of one or more of the plurality of chunk IDs are also described in more detail below in connection with relating each location ID to its corresponding chunk ID in step 108. The plurality of chunk IDs may be distributed sequentially, iteratively or in a data stream, and/or in batches.

One or more chunk type identifiers may also be distributed for storage in the chunk ID database 18 and/or in one or more of the storage devices 22 and databases 16, 20, as desired to improve performance of data retrieval, reporting, disaster recover and/or other administrative tasks. For instance, storing chunk type identifiers with transaction metadata data chunks in the chunk ID database 18 may help a system administrator retrieve transaction records according to transaction types. For example, a transaction type identifier comprising “e-mails” may be stored in all records in the chunk ID database parsed according to a transaction type exception configured to recognize transaction records including e-mails. A system administrator may then identify all such transaction records simply by querying the chunk ID database 18 and/or select fields therein looking for that particular chunk type identifier. It is foreseen that such metadata may be used in a variety of ways, preferably within the chunk ID database 18, to enhance data retrieval, reporting, disaster recovery and/or other administrative or similar tasks.

Also according to step 105, the plurality of location IDs is preferably distributed to the location ID database 20. The plurality of location IDs may be distributed sequentially, iteratively or in a data stream, and/or in batches. Moreover, the user key is also preferably distributed to the user key database 16.

Referring to step 106, the plurality of data chunks are preferably distributed for storage at respective designated storage devices 22. The plurality of data chunks may be distributed sequentially, iteratively or in a data stream, and/or in batches. Preferably, upon writing each data chunk to its designated storage device 22, the status for the corresponding chunk ID—stored by the core storage manager 32 in connection with step 103—may be changed to “used” or the like to indicate completion of the storage of the corresponding data chunk. In addition, in an embodiment, the memory location for each data chunk within the designated storage device 22 may be concatenated with the physical, virtual, and/or logical address of the designated storage device 22 to form the location ID for the corresponding data chunk, the location ID being written to the location ID database 20.

Referring now to step 107, the plurality of chunk IDs are preferably related to each other in the chunk ID database 18. The chunk ID database may be structured according to any of a number of types, including, for example, as a relational database, linked database, text database, desktop database program, array, NoSQL and/or object-oriented database. Techniques for forming relationships between data records according to these various database structures is generally known, and will not be discussed in further detail herein in connection with basic embodiments of the present invention. It should, however, be noted that each chunk ID of a transaction record may be keyed, connected or pointed toward one or more than one of the other chunk IDs, provided that there is at least one retrieval sequence—which may or may not rely on independent indices or the like for supplemental connectors—for locating the chunk IDs that successfully retrieves all chunk IDs for the complete transaction record.

It should also be noted that relating the chunk IDs within the chunk ID database may be replaced by or supplemented with linkages or relationships between chunk IDs defined collectively at the designated storage devices 22, without departing from the spirit of the present invention. In such embodiments, for example, each data chunk of a transaction record may be stored with its own chunk ID and the chunk ID of its successor data chunk. Relationships between chunk IDs may therefore be spread across multiple storage devices, further inhibiting assembly of the transaction record by unauthorized persons through hacking of any single device.

Referring to step 108, each location ID is preferably related to its corresponding chunk ID in at least one of the location ID database 20 and the chunk ID database 18. For instance, in an embodiment, each chunk ID may be stored in a record of the location ID database 20 with the corresponding location ID to form the relationship or link between them. It is foreseen that other known methods for linking or relating records between two databases or tables may be used to relate each location ID to the corresponding chunk ID within one or both of the location ID database 20 and the chunk ID database 18 without departing from the spirit of the present invention. Preferably, the location ID records are not related to one another within the location ID database 20. In an embodiment, none of the location ID records include a connector or pointer in the location ID database 20 to any other of the plurality of location ID records comprising the transaction record.

Referring to step 109, the user key is preferably related to the chunk ID corresponding to the first data chunk within the user key database 16. In a preferred embodiment, the chunk ID of the first data chunk may be stored in a record of the user key database 16 with the corresponding user key to form the relationship or link between them. Such a relationship preferably also, more broadly, enables linkage of the user with the transaction record's data chunks as a whole for authorized retrieval processes because the data chunks are, in turn, related via representative chunk IDs in the chunk ID database 18. It is foreseen that other known methods for linking or relating records between two databases or tables may be used to relate one or more of the chunk IDs to the user key without departing from the spirit of the present invention.

Referring to step 110, the storage process portion of the method 100 may be terminated. For example, in embodiments where a linked database structure is used for the chunk ID database 18, the address field for the final chunk of the transaction record may be populated with a terminator used to signify the end of a linked list or the like. Other indicators may also be used according to various database structures and types, or no indicator at all may be used and instead a final address field may for example be left unpopulated, to signify completion of storage of the transaction record.

Referring to step 111, the data manager 15 may receive a retrieval request and the user key. The thin client 30 and/or the user electronic device 14 may issue the retrieval request, and may pass the user key to the data manager 15 in conjunction with the request. The thin client 30 and/or the user electronic device 14 may also provide one or more parameters for the retrieval request to narrow the number of transaction records associated with the user key that are rendered back by the data manager 15. For instance, the thin client 30 may specify that only transaction records including one or more data chunks stored with an “e-mail” transaction type identifier should be rendered back to the thin client 30 in response to the retrieval request. It is also foreseen that dates/times or other metadata associated with the transaction records in one or more of databases 16, 18, 20 and/or storage devices 22 may be used to narrow the retrieval results without departing from the spirit of the present invention.

Referring to step 112, the user key may be located in one or more records in the user key database 16, and all relationships or connectors to the chunk ID database stored within such records of the user key database 16 may be retrieved and/or followed. In the preferred embodiment, the connectors comprise one or more chunk IDs of the first data chunk(s) of one or more transaction records.

Referring to step 113, the connectors—in the preferred embodiment, the chunk IDs of one or more first data chunks—are located in the chunk ID database. In the preferred embodiment, the direct and/or indirect relationships established between the first chunk IDs and the other chunk IDs of each transaction record within the chunk ID database (at step 107) may then be utilized to retrieve the remaining chunk IDs of each of the transaction record(s).

Referring to step 114, the plurality of chunk IDs retrieved from the chunk ID database may be used to retrieve the location IDs within the location ID database 20. More particularly, the relationship established at step 108 between each location ID and each corresponding chunk ID may be used to locate the location ID for each data chunk of the transaction record. In an embodiment, each chunk ID may be located within the location ID database so that its corresponding location ID—preferably stored within the same record—may be identified. Other relationships between the location IDs and chunk IDs are also within the ambit of the present invention, including an alternative relational technique described below in connection with another exemplary embodiment.

Referring now to step 115, the location IDs may be used to locate the designated storage devices 22 for the transaction record(s). The location IDs may, in an embodiment, include the memory location(s) for the data chunk in question. Alternatively or in addition, the record within the designated storage device 22 for each data chunk may have been written or amended in step 105 above to include one or more unique identifiers for the data chunk—for instance the chunk ID—which may be used to further locate the data chunk at the storage device 22 for retrieval.

Referring to step 116, once all of the data chunks have been retrieved from the designated storage devices 22, the core storage manager 32 may assemble the data chunks into the transaction record. It is also foreseen that the thin client 30 may perform the assembly without departing from the spirit of the present invention.

Referring to step 117, the transaction record and/or data chunks may be rendered to the thin client 30 and/or user electronic device 14 for use and/or display.

### Second Exemplary Computer-Implemented Method

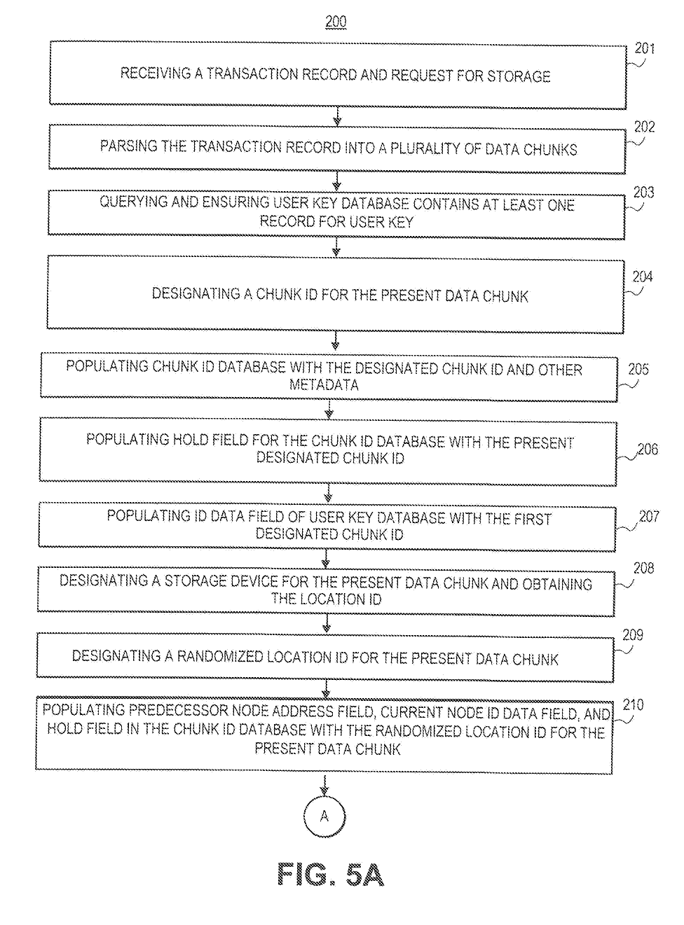

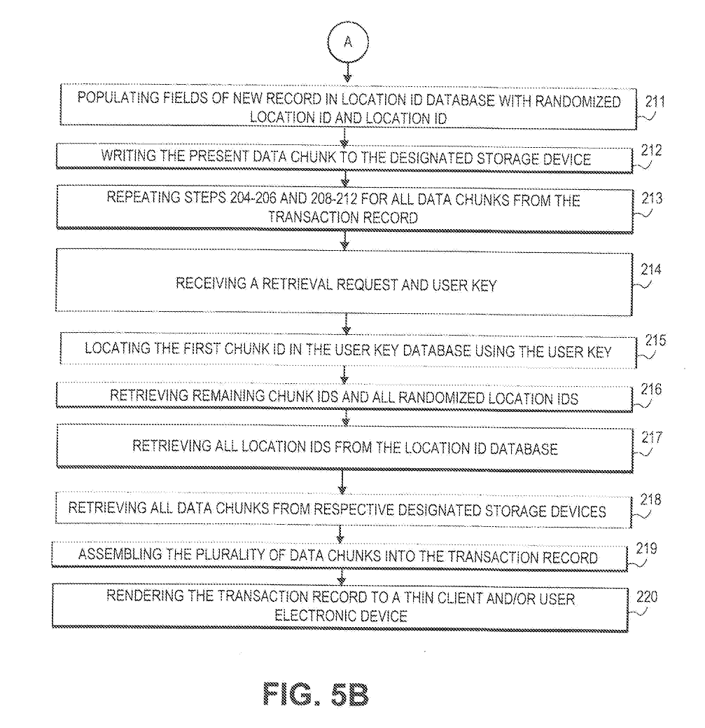

FIGS. 5A and 5B depict a listing of steps of an exemplary computer-implemented method 200 for storing information in a plurality of storage devices 22, and for retrieving the information and providing it to a thin client 30. The steps may be performed in the order shown in FIGS. 5A and 5B, or they may be performed in a different order. Furthermore, some steps may be performed concurrently as opposed to sequentially. In addition, some steps may be optional.

The computer-implemented method 200 is described below, for ease of reference, as being executed by exemplary devices introduced with the embodiments illustrated in FIGS. 1-3. For example, the steps of the computer-implemented method 200 may be performed by the computing device 10 through the utilization of processors, transceivers, hardware, software, firmware, or combinations thereof. However, a person having ordinary skill will appreciate that responsibility for all or some of such actions may be distributed differently among such devices or other computing devices without departing from the spirit of the present invention. A computer-readable medium may also be provided. The computer-readable medium may include an executable program, such as a data manager, stored thereon, wherein the program instructs one or more processing elements to perform all or certain of the steps outlined herein. The program stored on the computer-readable medium may instruct the processing element to perform additional, fewer, or alternative actions, including those discussed elsewhere herein.

It is initially noted that, with certain exceptions to be discussed in detail below, many of the steps utilized in the second exemplary method 200 are the same as or very similar to those described in detail above in relation to the first exemplary method 100 and in the opening paragraphs of this description. Furthermore, the computing and/or electronic devices and other network elements described above are suitable for use with the method 200 as well. Therefore, for the sake of brevity and clarity, redundant descriptions will be generally avoided here. Unless otherwise specified, the detailed descriptions of the steps and components presented above should therefore be understood to apply at least generally to the second exemplary method 200, as well.

Referring to step 201, the data manager 15 may receive a transaction record and a request for storage of the transaction record. The transaction record may, for example, broadly include a group of alphanumeric characters and a file. The data manager 15 may also receive metadata for certain of the fields of the transaction record. The metadata may include a label for a leading sequence of characters comprising “user ID.” The metadata may additionally include a label for a subsequent group of characters comprising “client name.”

The transaction record may be received in a single batch, though it is foreseen that the data manager 15 may incorporate a data buffer or the like for receiving streamed transaction records without departing from the spirit of the present invention.

Referring to step 202, the core storage manager 32 may parse the transaction record into a plurality of data chunks according to one or more parsing rules. The core storage manager 32 may maintain one or more list(s) of parsing rules, for example in the memory element 26 of the computing device. The core storage manager 32 may include one or more inference engines and/or semantic reasoners for applying the parsing rules. The core storage manager 32 may concurrently and/or sequentially apply some or all of the parsing rules it incorporates to parse the transaction record. The core storage manager 32 may be configured to identify one or more aspects of the transaction record and select or adjust the number and type of parsing rules to be applied accordingly.

The core storage manager 32 may, in this example, incorporate a user ID parsing rule, a client name parsing rule, a chunk size parsing rule, a transaction type exception parsing rule, and an artifact type exception parsing rule. The core storage manager 32 may consume the transaction record from beginning to end to identify sequences or portions of the transaction record that meet at least one condition set of at least one of the parsing rules. Where overlapping or identical portions of the transaction record satisfy multiple parsing rules, the core storage manager 32 is preferably configured to resolve such conflicts through, for example, prioritization of the operation of the satisfied parsing rules. For instance, the chunk size parsing rule may be of lowest priority, meaning that if a particular sequence of data also meets a set of conditions defined in the transaction type exception parsing rule, the transaction type exception parsing rule will supersede the chunk size parsing rule and delineate the sequence accordingly and without operation of the chunk size parsing rule.

With reference to exemplary segments of the transaction record set forth above, the transaction record may be consumed by the core storage manager 32 from beginning to end. It may be determined that all or part of a particular sequence of alphanumeric characters—for example “bobwhite153”—meets both a set of conditions of the user ID parsing rule as well as a set of conditions for the chunk size parsing rule. The set of conditions of the user ID parsing rule may include or consist of receiving the “user ID” metadata label in conjunction with the transaction record, as outlined above. The set of conditions of the chunk size parsing rule may have recommended delineating between chunks of data in the middle of the group of characters identified by the “user ID” metadata label, for example based on a byte size condition or the like. According to a prioritization schema applied by the core storage manager 32, the user key parsing rule may supersede the chunk size parsing rule and be applied to delineate “bobwhite153” as a data chunk. The core storage manager 32 may additional generate or pass a metadata label for the user ID data chunk such as “user ID” for storage in association with the data chunk, as described in more detail below.

It should be noted that in an embodiment—for example where the user has previously selected corresponding account settings defining its user key(s)—the core storage manager 32 may be configured to recognize satisfaction of the user ID parsing rule condition set as identification of the user key for the transaction record. In other implementations, the core storage manager 32 may be configured to treat a concatenation of the user ID and a client name (see discussion below), for example where both are provided in conjunction with and/or within the transaction record, as the user key. In still other implementations, the user key may be passed by the thin client 30 to the data manager 15 in conjunction with the transaction record.

The core storage manager 32 may similarly determine that another particular sequence of characters—such as “The Company” satisfies the client name parsing rule, whether through examination of the sequence of characters itself and/or receipt of the metadata label “client name” (or similar field identifier) received from the thin client 30 in conjunction with the transaction record. Again, the chunk size parsing rule may be superseded, and “The Company” may be parsed as an individual data chunk and associated with a metadata label such as “client name” for storage in association with the data chunk, as described in more detail below. In a similar fashion, other portions of the transaction record may be determined to respectively satisfy the transaction type exception parsing rule and the artifact type exception parsing rule. For instance, a sequence of characters beginning with “domain key . . . ” may be identified within an e-mail header of the transaction record and determined to satisfy the transaction type exception. Similarly, a subsequent e-mail file may be determined to satisfy the artifact type exception. A simple version of an artifact type exception parsing rule may be configured to recognize file extensions and/or file metadata without departing from the spirit of the present invention. Corresponding metadata labels may be generated and/or passed for association respectively with each data chunk parsed according to the specialized parsing rules.

Portions of the transaction record remaining after application of the higher priority, specialized parsing rules may be parsed according to the chunk size parsing rule. For instance, two remaining groups of characters in the transaction record may each be parsed into two separate data chunks as follows: “To be, or not to be: t”; “hat is the question.”; “Romeo romeo, where”; “fore art thou Romeo”. In this simple example, each data chunk parsed according to the chunk size parsing rule is sixteen (16) characters in length (not including spaces). It is foreseen that other chunk size parsing rules may be employed relating to other characteristics of the data of a transaction record—for instance by taking into account the difficulty of storing, encrypting, compressing or otherwise handling particular types of data—without departing from the spirit of the present invention. Because these data chunks were parsed without operation of a “special” parsing rule, for example one relating to the nature of the data in each chunk, a particularized metadata label may not be generated and/or passed by the core storage manager 32 for association therewith.

It should be noted that, for many types of transaction records—for example those containing data chunks without particularized metadata labels that might guide proper assembly of the transaction record during retrieval processes—the core storage manager 32 will at least temporarily store a record of the original sequence of the data chunks of the transaction record. For instance, regardless of the ordering of operation of the parsing rules described with the exemplary embodiment above, the core storage manager 32 preferably retains a record of the original order in which the data chunks appeared in the transaction record. In this case, the original transaction record may have been organized in the following order: bobwhite153TheCompanyTobeornottobe :thatisthequestiondomainkey[ . . . ] [artifact file]Romeoromeo,whereforeartthouRomeo. Following parsing and generation of the plurality of data chunks, the core storage manager 32 preferably retains a record, at least temporarily, of the original order of the data chunks in the transaction record.

In some instances, the ordering of relationships between the chunk IDs (see discussion below) within the chunk ID database may inherently preserve the original order of the data chunks. For example, the chunk IDs in some embodiments may be sequentially and iteratively stored to a chunk ID database 18 structured as a linked data structure including a plurality of nodes, with each node corresponding to one of the plurality of chunk IDs and comprising a plurality of fields, including a first field and a last, address field. The present chunk ID in such a chunk ID database 18 may be stored in the first field, and the address field may be populated by the chunk ID of the next, successor data chunk to be parsed from the transaction record. In such instances, the original ordering of the data chunks may be inherent in the means for relating the chunk IDs within the chunk ID database 18, i.e., in a linked list. This may be particularly true if, for example, the parsing rules delineate data chunks working progressively from the beginning of a transaction record to the end, storing each chunk ID in a new node in the chunk ID database 18 as its corresponding data chunk is delineated. In such embodiments or in other embodiments, however, an independent index or list is preferably kept, for example within the chunk ID database, to preserve the original order of the data chunks in the transaction record.

Referring now to step 203, the core storage manager 32 may query the user key database 16 using the user key determined from and/or provided within and/or in conjunction with the transaction record to determine whether it is already saved in a user key field in the user key database 16. FIG. 7 illustrates an exemplary segment 400 of the user key database 16 including USER KEY and ID DATA fields, captured just after step 203 is completed.

If the user key is not located, the core storage manager 32 may direct creation of a new record 402 and save the user key to a user key field therein. If the user key is located, the core storage manager 32 may be configured for either appending connectors to the chunk ID database 18 onto the end of the existing user key record in the user key database 16, or for generating a new record under the user key for the new transaction record being stored. In either case, the core storage manager 32 preferably also stores the user key to a hold field maintained by the core storage manager 32 to enable subsequent location of the record in the user key database 16 and relation between the record and at least a portion of the new transaction record being stored, according to other steps of the method 200.

Referring now to step 204, a chunk ID is designated by the data manager 15 for the first data chunk, in accordance with one or more of the methods previously described herein. For instance, the data chunk comprising “bobwhite153” may be assigned the chunk ID 24305159 by the data manager 15 using random number generator 38.

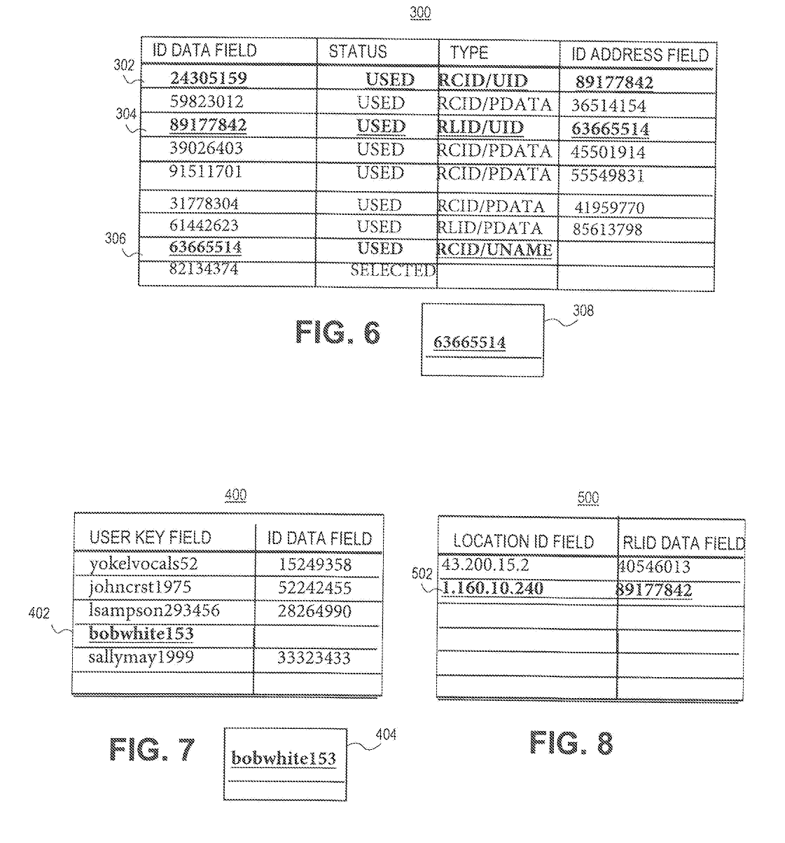

Referring to step 205, the core storage manager 32 may direct creation of a new record within the chunk ID database 18, and populate one or more of the data fields thereof. In the preferred embodiment, chunk ID database 18 is structured as a linked data structure including a plurality of nodes, with each node corresponding to one of the plurality of chunk IDs and comprising a plurality of fields, including a first field and a last, address field. An exemplary portion 300 of a linked list of the chunk ID database 18 is illustrated in FIG. 6, captured partway through the method 200 to better illustrate operation of the exemplary processes. The first chunk ID 24305159 is preferably written to a first field of a first record 302 associated with the present transaction record.

The core storage manager 32 may populate additional, preferably intermediate, fields within the new record 302 of the chunk ID database 18 with, for example, the chunk ID status (see discussion above) and a record type. An exemplary record 302 in the chunk ID database is illustrated as the first row in FIG. 6. It should be noted here that the record type field of the exemplary embodiment includes two pieces of metadata regarding the chunk ID stored in the first field of the record 302. Namely, the field is populated by the core storage manager 32 with an indicator that the first data field is a chunk ID (i.e., “RCID”) and with an abbreviated version of the metadata label “user ID” (i.e., “UID”) which was generated and/or passed according to the processes described above.

It is foreseen that any number of data fields and/or metadata may be included in data records of the chunk ID database 18 to enhance retrieval and/or administrative processes without departing from the spirit of the present invention. It should be noted, however, that in certain embodiments it will be desirable to obscure the type of data chunk corresponding to each record represented in the chunk ID database 18, and care is preferably taken to limit the amount of such information that may be obtained by, for example, hacking the chunk ID database 18. Therefore, one or more of the data fields in the chunk ID database may contain connectors or pointers to other, standalone databases for storing such potentially sensitive metadata without departing from the spirit of the present invention.

Referring to step 206, the core storage manager 32 also preferably saves the first chunk ID 24305159 to a hold field 308 for the chunk ID database 18 maintained by the data manager 15. This preferably permits the core storage manager 32 to locate and return to the first record 302 in the linked list, for example to relate the first chunk ID to the next node in the linked list corresponding to the transaction record using a connector. In this example, the core storage manager 32 returns using the hold field 308 to populate the ID ADDRESS FIELD with the value stored in the ID DATA FIELD of the successor node in the list, forming a relationship between the two nodes for retrieval purposes. It should be noted that the portion 300 of the linked list illustrated in FIG. 6 was captured later in the storage process, and therefore the hold field 308 is illustrated as being populated with the ID DATA FIELD value of later record 306.

Referring to step 207, the core storage manager 32 may return to the user key database 16 to relate the user key for the transaction record to the transaction record within the chunk ID database 18. More particularly, the core storage manager 32 preferably directs storage of a connector to the first record 302 in the ID DATA FIELD of the user key database 16 (see FIG. 7). Preferably, the connector comprises the first chunk ID 24305159.

Referring to step 208, the data manager 15 may designate a storage device 22 corresponding to the first data chunk. The core storage manager 32 may call the storage device assignor 34, which may obtain a list of eligible devices 22 from the storage device database 36 and randomly select one to designate. In the exemplary embodiment, the core storage manager 32 passes the client name obtained from the transaction record to the storage device assignor 34. The storage device assignor 34 generates and/or locates a list of storage devices 22 populated according to the user account settings and parameters particular to the user. Once designated, the data manager 15 may hold the location ID associated with the designated storage device 22 temporarily in the memory element 26 of the computing device 10.

Referring to step 209, the core storage manager 32 may generate a random number to represent the location ID, which preferably permits relating the transaction record across the location ID database 20 and the chunk ID database 18 in a manner which enhances the dispersion of valuable information across standalone devices of embodiments of the present invention. More particularly, the core storage manager 32 may call the random number generator 38, receive a random number candidate, check the random number candidate against the chunk ID database 18 to ensure it is unique, and designate the random number as the randomized location ID representing the first data chunk. Referring to the exemplary segment 300 of the chunk ID database 18 illustrated in FIG. 6, the randomized location ID for the first data chunk is 89177842.

Referring to step 210, the core storage manager 32 locates the record 302 in the chunk ID database 18 corresponding to the value in the hold field 308 (at this point, the value in the hold field 308 would have been the first chunk ID 24305159). The core storage manager 32 may then instruct that the ID ADDRESS FIELD of record 302 be populated with a connector to a new, second record 304 for with the transaction record. The core storage manager 32 may also populate the ID DATA FIELD of record 304 with the randomized location ID 89177842, and update the status for the random number of the randomized location ID in the STATUS field, as well as populate the TYPE field to indicate that the record relates to a randomized location ID (i.e., using the “RLID” label) and to indicate that the randomized location ID is for the first data chunk, which is a user ID data chunk (i.e., using the “UID” label). Finally, the core storage manager 32 may update the hold field 308 so that it is populated with the value of the randomized location ID (89177842).

Referring to step 211, the core storage manager 32 may relate the location ID for the designated storage device 22 of the first data chunk to the records of the chunk ID database 18. In the preferred embodiment, the relationship is recorded in the location ID database 20. An exemplary portion 500 of the location ID database 20 is illustrated in FIG. 8. The core storage manager 32 may instruct and/or direct creation of a new record 502 in the location ID database 20. The core storage manager 32 may direct that a LOCATION ID FIELD be populated with the location ID of the designated storage device 22 (in this case, 1.160.10.240). The core storage manager 32 may also direct that a RLID DATA FIELD be populated with the randomized location ID generated according to step 209 (in this case, 89177842).

Referring to step 212, the data manager 15 may write the first data chunk to the designated storage device 22 addressed at 1.160.10.240. The data manager 15 may write the first data chunk to one or more data fields, and may also write the chunk ID (i.e., 24305159) for the first data chunk to another data field in the designated storage device 22. It is also foreseen that additional data fields may be populated in the record at the designated storage device 22, such as numbers to assist with disaster recovery, simplify administrative retrieval processes, or the like. In certain embodiments, the randomized location ID may be written to a field in the record at the designated storage device 22. In some embodiments, chunk IDs associated with other data chunks of the transaction record may also be written to field(s) in the record at the designated storage device 22, for example if additional relationships between the chunk IDs outside the chunk ID database 18 are desired.

Referring to step 213, the data manager 15 may repeat steps 204-206 and 208-212 for each of the plurality of data chunks of the transaction record. Broadly, the data manager 15 creates and populates records in the chunk ID database 18 alternately corresponding to chunk IDs and randomized location IDs—with each pair of chunk ID/randomized location ID records corresponding to a single data chunk—and creates and populates a record in the location ID database for each data chunk. The data manager 15 may signify the end of the transaction record once steps 204-206 and 208-212 have been completed for all data chunks of the transaction record, for instance by storing a terminator in the ID ADDRESS FIELD of the chunk ID database 18 for the record associated with the randomized location ID of the final data chunk.

Referring to step 214, the data manager 15 may receive a retrieval request and the user key “bobwhite153”.

Referring to step 215, the user key “bobwhite153” may be located in record 402 in the user key database 16 (see FIG. 7), and the connector to the chunk ID database 18 (i.e., 24305159) may be retrieved. It should be noted that the connector to the chunk ID database 18 (i.e., 24305159) does not yet appear in record 402 as of the time the view in FIG. 7 was captured, but that the steps outlined herein would preferably have populated the ID DATA FIELD in this manner prior to initiation of the retrieval steps of the method 200.

Referring to step 216, the connector 24305159 is located in the chunk ID database 18. The linked list (see FIG. 6) may then be utilized to retrieve the remaining chunk IDs and all corresponding randomized location IDs of the transaction record. It should be noted that records 302, 304 and 306 correspond to the present transaction record, whereas non-bolded/underlined records interspersed therebetween are entries into the chunk ID database 18 made by other, unrelated processes. FIGS. 7 and 8 are similarly depicted.

Referring to step 217, the plurality of randomized location IDs retrieved from the chunk ID database may be used to retrieve the location IDs within the location ID database 20.

Referring now to step 218, the location IDs may be used to locate the designated storage devices 22 for the transaction record. Each data chunk may be respectively retrieved from its designated storage device 22 with reference to its chunk ID.

Referring to step 219, once all of the data chunks have been retrieved from the designated storage devices 22, the core storage manager 32 may assemble the data chunks into the transaction record. It is also foreseen that the thin client 30 may perform the assembly without departing from the spirit of the present invention.

Referring to step 220, the transaction record and/or data chunks may be rendered to the thin client 30 and/or user electronic device 14 for use and/or display.

It should be noted that even where not expressly described above, the core storage manager 32 may create temporary copies of the contents of the data fields until related steps, processes and/or write operations are completed.

### Additional Considerations

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current technology can include a variety of combinations and/or integrations of the embodiments described herein.

Although the present application sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processing element, may be implemented as special purpose or as general purpose. For example, the processing element may comprise dedicated circuitry or logic that is permanently configured, such as an application-specific integrated circuit (ASIC), or indefinitely configured, such as an FPGA, to perform certain operations. The processing element may also comprise programmable logic or circuitry (e.g., as encompassed within a general-purpose processor or other programmable processor) that is temporarily configured by software to perform certain operations. It will be appreciated that the decision to implement the processing element as special purpose, in dedicated and permanently configured circuitry, or as general purpose (e.g., configured by software) may be driven by cost and time considerations.

Accordingly, the term “processing element” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processing element is temporarily configured (e.g., programmed), each of the processing elements need not be configured or instantiated at any one instance in time. For example, where the processing element comprises a general-purpose processor configured using software, the general-purpose processor may be configured as respective different processing elements at different times. Software may accordingly configure the processing element to constitute a particular hardware configuration at one instance of time and to constitute a different hardware configuration at a different instance of time.

Computer hardware components, such as communication elements, memory elements, processing elements, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices, and may operate on a resource (e.g., a collection of information).

The various operations of example methods described herein may be performed, at least partially, by one or more processing elements that are temporarily configured (e.g., by software) or permanently configured to perform the relevant operations. Whether temporarily or permanently configured, such processing elements may constitute processing element-implemented modules that operate to perform one or more operations or functions. The modules referred to herein may, in some example embodiments, comprise processing element-implemented modules.

Similarly, the methods or routines described herein may be at least partially processing element-implemented. For example, at least some of the operations of a method may be performed by one or more processing elements or processing element-implemented hardware modules. The performance of certain of the operations may be distributed among the one or more processing elements, not only residing within a single machine, but deployed across a number of machines. In some example embodiments, the processing elements may be located in a single location (e.g., within a home environment, an office environment or as a server farm), while in other embodiments the processing elements may be distributed across a number of locations.

For instance, many of the operations described herein as being performed according to instructions of a data manager may be outsourced to one or more user electronic devices and/or thin clients without departing from the spirit of the present inventive concept. In an embodiment, a so-called “thin” client application for performing only the most basic functions locally at each user electronic device may be replaced by a more robust local client application by one having ordinary skill in the art following review of this description. Alternatively or in addition, it is foreseen that functions described herein as resulting from execution of a thin client or other local software application interfacing with the data manager may instead be outsourced to the data manager without departing from the spirit of the present inventive concept.

Unless specifically stated otherwise, discussions herein using words such as “processing,” “computing,” “calculating,” “determining,” “presenting,” “displaying,” or the like may refer to actions or processes of a machine (e.g., a computer with a processing element and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

The patent claims at the end of this patent application are not intended to be construed under 35 U.S.C. §112(f) unless traditional means-plus-function language is expressly recited, such as “means for” or “step for” language being explicitly recited in the claim(s).

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. (canceled)

2. The computer-implemented method of claim 6, wherein the transaction record is parsed at least in part based on a chunk size condition.

3. The computer-implemented method of claim 2, wherein the transaction record is parsed in part based on a transaction type exception, and the plurality of data chunks includes a transaction metadata data chunk parsed from the transaction record according to the transaction type exception.

4. The computer-implemented method of claim 3, further comprising storing a transaction type identifier with the chunk ID of the transaction metadata data chunk in the chunk ID database.

5. The computer-implemented method of claim 10, wherein the transaction record is parsed in part based on an artifact type exception, and wherein the plurality of data chunks includes an artifact data chunk parsed from the transaction record according to the artifact type exception.

6. A computer-implemented method for storing information in a plurality of storage devices, the computer-implemented method comprising, via one or more processors and/or transceivers:
receiving a transaction record;
parsing the transaction record into a plurality of data chunks including an artifact data chunk, the transaction record being parsed at least in part based on a chunk size condition and at least in part based on an artifact type exception, the artifact data chunk being parsed from the transaction record according to the artifact type exception;
designating a storage device having a location ID for each of the plurality of data chunks;
designating a chunk ID for each of the plurality of data chunks;
distributing the location IDs to a location ID database;
distributing the chunk IDs to a chunk ID database;
distributing each of the plurality of data chunks to the corresponding designated storage device for storage;
relating the plurality of chunk IDs to each other in the chunk ID database;
relating each location ID to the corresponding chunk ID in at least one of the location ID database and the chunk ID database; and
storing an artifact type identifier with the chunk ID of the artifact data chunk in the chunk ID database.

7. The computer-implemented method of claim 6, wherein designating each of the chunk IDs includes
generating a random number,
checking a log file to ensure that the random number is not already in use in the system,
storing the random number in the log file to indicate the designation.

8. The computer-implemented method of claim 6, wherein at least one of the plurality of location IDs is not stored on the same computing device as the chunk ID database.

9. The computer-implemented method of claim 6, wherein designating a storage device for each of the plurality of data chunks includes randomly selecting a storage device from a plurality of storage devices.

10. A computer-implemented method for storing information in a plurality of storage devices, the computer-implemented method comprising, via one or more processors and/or transceivers:
receiving a transaction record;
parsing the transaction record into a plurality of data chunks;
designating a storage device having a location ID for each of the plurality of data chunks;
designating a chunk ID for each of the plurality of data chunks;
distributing the location IDs to a location ID database;
distributing the chunk IDs to a chunk ID database;
distributing each of the plurality of data chunks to the corresponding designated storage device for storage;
relating the plurality of chunk IDs to each other in the chunk ID database; and
relating each location ID to the corresponding chunk ID in at least one of the location ID database and the chunk ID database,
wherein
the chunk ID database comprises a linked data structure including a plurality of nodes with each node corresponding to one of the plurality of chunk IDs, the plurality of chunk IDs being distributed to the chunk ID database sequentially and iteratively,
distributing and relating the plurality of chunk IDs to each other in the chunk ID database includes, for each of the plurality of chunk IDs except a first chunk ID of the transaction record
locating the chunk ID of a predecessor node in a hold system ID field;
locating the predecessor node using the chunk ID of the hold system ID field;
storing the present chunk ID to an address field of the predecessor node;
creating a present node;
storing the present chunk ID to a data field of the present node;
storing the present chunk ID to the hold system ID field.

11. The computer-implemented method of claim 10, wherein distributing and relating the plurality of chunk IDs to each other in the chunk ID database includes creating a first node in the chunk ID database and storing the first chunk ID of the transaction record to a data field of the present node, further comprising distributing the first chunk ID to a user key database.

12. The computer-implemented method of claim 11, further comprising relating the first chunk ID to a user key in the user key database.

13. The computer-implemented method of claim 6, wherein relating each location ID to the corresponding chunk ID comprises distributing the plurality of chunk IDs for storage with respective corresponding location IDs in the location ID database.

14. The computer-implemented method of claim 6, wherein relating each location ID to the corresponding chunk ID comprises, for each location ID
generating an abstracted location ID, the abstracted location ID being created through generating a random number and checking the random number against a log file to ensure that the random number is not already in use in the system;
storing the abstracted location ID with each of: (a) the corresponding location ID in the location ID database, and (b) the corresponding chunk ID in the chunk ID database.

15. A computer-implemented method for storing information in a plurality of storage devices, the computer-implemented method comprising, via one or more processors and/or transceivers:
receiving a transaction record;
parsing the transaction record into a plurality of data chunks;
designating a storage device having a location ID for each of the plurality of data chunks;
designating a chunk ID for each of the plurality of data chunks;
distributing the location IDs to a location ID database;
distributing the chunk IDs to a chunk ID database;
distributing each of the plurality of data chunks to the corresponding designated storage device for storage;
relating the plurality of chunk IDs to each other in the chunk ID database; and
relating each location ID to the corresponding chunk ID in at least one of the location ID database and the chunk ID database including by performing the following for each location ID
generating an abstracted location ID, the abstracted location ID being created through generating a random number and checking the random number against a log file to ensure that the random number is not already in use in the system,
storing the abstracted location ID with each of: (a) the corresponding location ID in the location ID database, and (b) the corresponding chunk ID in the chunk ID database,
wherein
the chunk ID database comprises a linked data structure including a plurality of nodes, the plurality of nodes alternatingly corresponding to one of the plurality of chunk IDs or one of the plurality of abstracted location IDs,
distributing and relating the plurality of chunk IDs to each other in the chunk ID database includes, for each of the plurality of chunk IDs except a first chunk ID of the transaction record
locating the abstracted location ID of a predecessor node in a hold system ID field;
locating the predecessor node using the abstracted location ID of the hold system ID field;
storing the present chunk ID to an address field of the predecessor node;
creating a present node;
storing the present chunk ID to a data field of the present node;
storing the present chunk ID to the hold system ID field.

16. The computer-implemented method of claim 15, wherein distributing and relating the plurality of chunk IDs to each other in the chunk ID database includes creating a first node in the chunk ID database and storing the first chunk ID of the transaction record to a data field of the present node further comprising distributing the first chunk ID to a user key database.

17. The computer-implemented method of claim 16, further comprising relating the first chunk ID to a user key in the user key database.

18. The computer-implemented method of claim 6, wherein each of the designated storage devices comprises a separate, standalone silo.

19. The computer-implemented method of claim 6, wherein the location IDs are not related or linked to each other within the location ID database.

20. The computer-implemented method of claim 6, wherein each location ID includes a unique identifier enabling location of the corresponding designated storage device, the method further comprising distributing each of the plurality of chunk IDs to the corresponding designated storage devices for storage with corresponding data chunks.

21. The computer-implemented method of claim 6, wherein each location ID includes a unique identifier enabling location of the corresponding designated storage device and a physical address of a memory location of the corresponding data chunk at the designated storage device.

22. The computer-implemented method of claim 6, 10 or 15, wherein at least one of the plurality of location IDs, the user key database, and the chunk ID database are each stored on a separate, standalone silo computing device.
